(19) United States
(12) Patent Application Publication
(10) Pub. No.: US 2016/0099498 A1
(43) Pub. Date: Apr. 7, 2016

(54) MAGNETO-DIELECTRIC SUBSTRATE, CIRCUIT MATERIAL, AND ASSEMBLY HAVING THE SAME

(71) Applicant: ROGERS CORPORATION, Rogers, CT (US)

(72) Inventors: Kristi Pance, Auburndale, MA (US); Karl Sprentall, Scottsdale, AZ (US); Murali Sethumadhavan, Acton, MA (US)

(21) Appl. No.: 14/870,273

(22) Filed: Sep. 30, 2015

Related U.S. Application Data
(60) Provisional application No. 62/058,833, filed on Oct. 2, 2014.

(51) Int. Cl. H01Q 1/38; H01F 10/28; H01F 1/055; H01Q 1/48

(52) U.S. Cl. CPC H01Q 1/38; H01Q 1/48; H01F 10/28; H01F 1/0551

(57) ABSTRACT

A magneto-dielectric substrate includes a first dielectric layer, a second dielectric layer spaced apart from the first dielectric layer, and at least one magnetic reinforcing layer disposed between and in intimate contact with the first dielectric layer and the second dielectric layer.

### CROSS REFERENCE TO RELATED APPLICATIONS

This application claims the benefit of U.S. Provisional Application Ser. No. 62/058,833, filed Oct. 2, 2014, which is incorporated herein by reference in its entirety.

### BACKGROUND OF THE INVENTION

The present disclosure relates generally to a magneto-dielectric substrate, particularly to a metal clad circuit material employing a magneto-dielectric substrate, and more particularly to an antenna employing a metal clad circuit laminate employing a magneto-dielectric substrate.

Newer designs and manufacturing techniques have driven electronic components to increasingly smaller dimensions, for example inductors on electronic integrated circuit chips, electronic circuits, electronic packages, modules and housings, and UHF, VHF, and microwave antennas. Reduction in antenna size has been particularly problematic, and antennas have not been reduced in size at a comparative level to other electronic components. One approach to reducing electronic component size has been the use of magneto-dielectric materials as substrates. In particular, ferrites, ferroelectrics and multiferroics have been widely studied as functional materials with enhanced microwave properties. However, these materials are not entirely satisfactory, in that they may not provide the desired bandwidth or have the desired mechanical performance for a given application.

There accordingly remains a need in the art for magneto-dielectric substrates with low dielectric and magnetic losses, low power consumption, low biasing electric or magnetic fields, and improved mechanical properties. It would be a further advantage if the materials, were easily processable and integrable with existing fabrication processes.

### BRIEF DESCRIPTION OF THE INVENTION

An embodiment of the invention includes a magneto-dielectric substrate having a first dielectric layer, a second dielectric layer spaced apart from the first dielectric layer, and at least one magnetic reinforcing layer disposed between and in intimate contact with the first dielectric layer and the second dielectric layer.

The above features and advantages and other features and advantages are readily apparent from the following detailed description when taken in connection with the accompanying drawings.

### BRIEF DESCRIPTION OF THE DRAWINGS

Referring to the exemplary non-limiting drawings wherein like elements are numbered alike in the accompanying Figures:

FIG. 1 depicts a section view of a magneto-dielectric substrate having a magnetic layer, in accordance with an embodiment;

FIG. 2 depicts a section view of a metal clad circuit material employing the magneto-dielectric substrate of FIG. 1, in accordance with an embodiment;

FIG. 3 depicts a section view of the metal clad circuit laminate of FIG. 2 with a patterned patch, in accordance with an embodiment;

FIG. 4A depicts a detail view of a portion of FIG. 1, with cross-hatch detail omitted for clarity, depicting an expanded view of an embodiment of the magnetic layer in accordance with an embodiment;

FIG. 4B depicts an alternative detail view of a portion of FIG. 1, with cross-hatch detail omitted for clarity, depicting an expanded view of an alternative embodiment of the magnetic layer in accordance with an embodiment;

FIG. 4C depicts an alternative detail view of a portion of FIG. 1, with cross-hatch detail omitted for clarity, depicting an expanded view of an alternative embodiment of the magnetic layer in accordance with an embodiment;

FIG. 4D depicts an alternative detail view of a portion of FIG. 1, with cross-hatch detail omitted for clarity, depicting an expanded view of an alternative embodiment of the magnetic layer in accordance with an embodiment;

FIG. 4E depicts an alternative detail view of a portion of FIG. 1, with cross-hatch detail omitted for clarity, depicting an expanded view of an alternative embodiment of the magnetic layer in accordance with an embodiment;

FIG. 5 depicts a cross section view, with cross-hatch detail omitted for clarity, of a portion of the metal clad circuit laminate of FIGS. 2 and 4C, in accordance with an embodiment;

FIG. 6A depicts an isometric view of an antenna in accordance with an embodiment;

FIG. 6B depicts a side view of the antenna of FIG. 6A, in accordance with an embodiment;

FIG. 6C depicts a top view of the antenna of FIG. 6A, in accordance with an embodiment;

FIG. 7 depicts comparative beam widths at an H-Field plane illustrating a performance advantage of an embodiment;

FIG. 8 depicts comparative beam widths at an E-Field plane illustrating a performance advantage of an embodiment; and

FIG. 9 depicts comparative impedance bandwidths and gain bandwidths illustrating a performance advantage of an embodiment.

### DETAILED DESCRIPTION

Described herein are magneto-dielectric substrates and electronic devices containing the substrates, such as circuit materials and antennas, wherein the magneto-dielectric substrates include a reinforcing magnetic layer disposed in a dielectric material. Use of a magnetic reinforcing layer in the substrates unexpectedly provides excellent magneto-electronic properties in combination with excellent mechanical properties. The substrates can further be processed by methods that are readily integrated into current manufacture methods for electronic devices.

As shown and described by the various figures and accompanying text, a magneto-dielectric substrate has a magnetic reinforcing layer disposed within and in intimate contact with a dielectric layer. In general, the magnetic reinforcing layer is centrally disposed in the dielectric layer and has a structure that provides structural reinforcement of the first and second dielectric layers. In an embodiment, a conductive layer is additionally disposed on a side of the magneto-dielectric substrate to provide a single clad circuit material that can be configured for use in a wide variety of electronic devices. For example, the conductive layer can be patterned to provide a circuit. In another embodiment, the magneto-dielectric substrate is sandwiched between a conductive ground layer (ground plane) and a conductive element (patch) to provide a double clad circuit material, with a signal line, such as a coaxial cable or a feeder strip, disposed in signal communication with the patch, to form the basic structure for a miniaturized high frequency antenna having improved bandwidth.

The single clad circuit material can be formed by forming the reinforcing magnetic layer; casting or laminating the first and second dielectric layer onto the magnetic layer; and adhering or laminating a conductive layer to the first or second dielectric layer. The double clad circuit material can be formed by forming the magnetic layer; casting or laminating the first and second dielectric layer onto the magnetic layer; and applying a first and a second conductive element to the first and second dielectric layer simultaneously or sequentially.

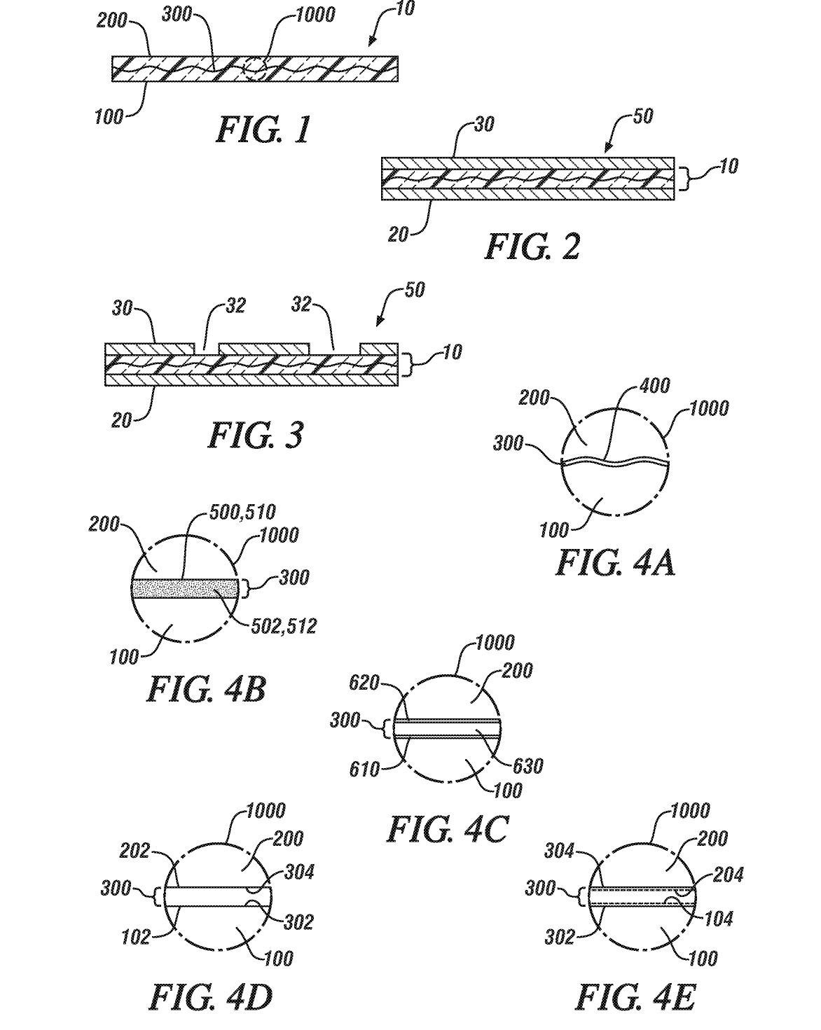

FIG. 1 depicts an embodiment of a magneto-dielectric substrate 10 having a first dielectric layer 100, a second dielectric layer 200 uniformly spaced apart from the first dielectric layer 100, and a magnetic reinforcing layer 300 disposed between and in intimate contact with the first dielectric layer 100 and the second dielectric layer 200. Additional dielectric layers (depicted generally by reference numeral 300) may optionally be present to provide desired properties to the substrates.

While magnetic reinforcing layer 300 is depicted in FIG. 1 by a wavy line having a “line-thickness”, it will be appreciated from the disclosure herein that such depiction is for general illustrative purposes and is not intended to limit the scope of the embodiments disclosed herein. For example, in an embodiment, the first dielectric layer 100, the second dielectric layer 200, and the magnetic reinforcing layer 300, may each be continuously planar in structure, or the magnetic reinforcing layer 300 may be a woven or nonwoven fibrous material that allows contact between the first dielectric layer 100 and the second dielectric layer 200 through voids in the reinforcing layer 300, or the magnetic reinforcing layer 300 may be a magnetic woven material impregnated with a polymer. Thus, in an embodiment, the first dielectric layer 100 is structurally macroscopically in-plane continuous, the second dielectric layer 200 is structurally macroscopically in-plane continuous, and the magnetic reinforcing layer 300 is at least partially structurally macroscopically in-plane continuous. As used herein, the term at least partially structurally macroscopically in-plane continuous includes both a solid layer, and a fibrous layer (such as a woven or non-woven layer) that may have macroscopic voids. When the magnetic reinforcing layer 300 is a solid layer, the first dielectric layer 100 is wholly separated from the second dielectric layer 200. When the magnetic reinforcing layer is in the form of a woven or nonwoven fabric, the terms “first dielectric layer 100” and “second dielectric layer 200” refer to the regions on each side of the magnetic reinforcing layer 300, and do not limit the various embodiments to two separate layers. In an embodiment, the magnetic layer 300 has a material characteristic that includes in-plane magnetic anisotropy. FIG. 1 depicts detail 1000, which is described below with reference to FIGS. 4A, 4B, 4C, 4D, and 4E.

The magnetic reinforcing layer 300 comprises a magnetic material and a reinforcing material in combination as described in further detail below. The first and second dielectric layers 100, 200 comprise a polymer dielectric composition as further described below.

Magneto-dielectric substrates 10 are useful in the manufacture of a wide variety of electronic devices. In an embodiment, a single clad circuit material comprises a magneto-dielectric substrate 10 and a conductive metal layer, as further described below, disposed on a side of substrate 10. Patterning the conductive layer, as described in further detail below, provides a circuit.

FIG. 2 depicts the magneto-dielectric substrate 10 of FIG. 1 sandwiched between electrical conductors 20 and 30 to form a double clad circuit material 50. In an embodiment, conductors 20 and 30 serve as a conductive ground layer 20, and a conductive element 30, which will be discussed in more detail below.

FIG. 3 depicts a double clad circuit material 50 having the conductive layer 30 patterned via etching, milling, or any other suitable method, which will be discussed in more detail below. As used herein, the term “patterned” includes an arrangement where the conductive element 30 has in-line and in-plane conductive discontinuities 32.

The fibers can comprise a magnetic material, for example, a hexaferrite magnetic material. The hexaferrite magnetic material can comprise Sr, Ba, Co, Ni, Zn, V, Mn, or a combination comprising at least one of the foregoing, specifically Ba and Co. The magnetic material can comprise a ferromagnetic material such as ferrite, ferrite alloy, cobalt, cobalt alloy, iron, iron alloy, nickel, nickel alloy, or a combination comprising at least one of the foregoing magnetic materials. The magnetic material can comprise hexaferrite, magnetite (Fe₃O₄), and MFe₂O₄, wherein M comprises at least one of Co, Ni, Zn, V, and Mn, specifically, Co, Ni, and Mn. The magnetic material can comprise a metal iron oxide of the formula MₓFe_{y}O_{z}, for example, MFe₁₂O₁₉, Fe₃O₄, MFe₂₄O₄₁, or MFe₂O₄, wherein M is Sr, Ba, Co, Ni, Zn, V, and Mn; specifically, Co, Ni, and Mn; or a combination comprising at least one of the foregoing. As is known in the art, hexaferrites, are magnetic iron oxides having a hexagonal structure that can comprise Al, Ba, Bi, Co, Ni, Ir, Mn, Mg, Mo, Nb, Nd, Sr, V, Zn, Zr, or a combination comprising one or more of the foregoing. Different types of hexaferrites include, but are not limited to, M-type ferrites, such as BaFe₁₂O₁₉ (BaM or barium ferrite), SrFe₁₂O₁₉ (SrM or strontium ferrite), and cobalt-titanium substituted M ferrite, Sr— or BaFe₁₂₋₂xCoxTixO₁₉ (CoTiM); Z-type ferrites (Ba₃Me₂Fe₂₄O₄₁) such as Ba₃Co₂Fe₂₄O₄₁ (Co₂Z); Y-type ferrites (Ba₂Me₂Fe₁₂O₂₂), such as Ba₂Co₂Fe₁₂O₂₂ (Co₂Y) or Mg₂Y; W-type ferrites (BaMe₂Fe₁₆O₂₇), such as BaCo₂Fe₁₆O₂₇ (Co₂W); X-type ferrites (Ba₂Me₂Fe₂₈O₄₆), such as Ba₂Co₂Fe₂₈O₄₆ (Co₂X); and U-type ferrites (Ba₄Me₂Fe₃₆O₆₀), such as Ba₄Co₂Fe₃₆O₆₀ (Co₂U), wherein in the foregoing formulas, Me is a +2 ion, and Ba can be substituted by Sr. Specific hexaferrites further comprise Ba and Co, optionally together with one or more other divalent cations (substituted or doped). The magnetic material can comprise ferromagnetic cobalt carbide (such as Co₂C and Co₃C phases), for example, barium cobalt Z Type hexaferrite (Co₂Z Ferrite). The magnetic material can be present in the form of one or both of a fiber and a particle.

In an embodiment, and with reference to detail 1000 in FIG. 4A, the magnetic reinforcing layer 300 is a fibrous magnetic layer 400. In this embodiment, a plurality of the fibers are a magnetic material, for example, as described above. The fibers can comprise ferrite fibers, ferrite alloy fibers, cobalt fibers, cobalt alloy fibers, iron fibers, iron alloy fibers, nickel fibers, and nickel alloy fibers. In an embodiment, the fibers are hexaferrite, magnetite (Fe₃O₄), or MFe₂O₄, wherein M is at least one of Co, Ni, Zn, V, or Mn, specifically, at least one of Co, Ni, or Mn. In any of the magnetic materials used herein, paramagnetic elements such as platinum, aluminum, and oxygen can be present, or a lanthanide element.

The fibers can be singular or individual fibers can be twisted, roped, knit, braided, or the like. The fibers can have diameters in the micrometer or nanometer range, for example from 2 nanometers (nm) to 10 micrometers, or from 2 nanometers to 500 nanometers, or from 500 nanometers to 5 micrometers. In an embodiment, the fibers have an average fiber diameter over the length of the fiber of 50 nm to 10 micrometers, or 50 nm to less than or equal to 900 nm, specifically, 20 to 250 nm.

Fibrous magnetic layer 400 may be in the form of a cloth comprising the fibers. The cloth may be woven or non-woven, such as a felt. The cloth can include magnetic fibers only, or a combination of magnetic and non-magnetic fibers (e.g., glass fibers, or polymer-based magnetic fibers as described below), provided that the magnetic fibers are present in an amount effective to provide the desired properties. In specific embodiments, fibrous magnetic layer 400 is a cloth such as a ferrite or ferrite alloy cloth, a cobalt or cobalt alloy cloth, an iron or iron alloy cloth, or a nickel or nickel alloy cloth, for example. Such thermally stable fiber reinforcement reduces shrinkage of the magneto-dielectric substrate upon cure within the plane of the substrate. In addition, the use of the cloth reinforcement renders a substrate with a relatively high mechanical strength. Such substrates are more readily processed by methods in commercial use, for example lamination, including roll-to-roll lamination.

In an embodiment, and with reference to detail 1000 in FIG. 4B, the magnetic layer 300 is a polymer (such as a liquid crystal polymer, polyetherimide, polyether ketone, polysulfone, polyethersulfones, polycarbonate, polyester, or the like) with magnetic particles dispersed therein. In this embodiment, the magnetic layer can be a cloth as described above comprising polymer fibers or nanofibers 500 with magnetic particles 502 dispersed therein, or a continuous polymer layer 510 with magnetic nano-particles 512 dispersed therein such as is described in further detail in connection with FIG. 4D below.

The magnetic material as described above can be in the form of a magnetic particle. The magnetic particles can comprise one or both of magnetic nano-particles and micrometer sized particles. The size of the magnetic particles is not particularly limited and can have a D₅₀ value by mass of 10 nm to 10 micrometers, specifically, 100 nm to 5 micrometers, more specifically, 1 to 5 micrometers. The magnetic nano-particles can have a D₅₀ value by mass of 1 to 900 nm, specifically, 1 to 100 nm, more specifically, 5 to 10 nm. The magnetic micro-particles can have a D₅₀ value by mass of 1 to 10 micrometers, specifically, 2 to 5 micrometers. The magnetic particles can be irregular or regular, for example spherical, ovoid, polygonal flakes, and the like. The magnetic particles can comprise ferromagnetic particles such as ferrite, ferrite alloy, cobalt, cobalt alloy, iron, iron alloy, nickel, nickel alloy, or a combination comprising at least one of the foregoing magnetic materials. In a specific embodiment, the magnetic particles comprise hexaferrite, magnetite (Fe₃O₄), and MFe₂O₄, wherein M comprises at least one of Co, Ni, Zn, V, and Mn, specifically, Co, Ni, and Mn. The magnetic particles can be surface-treated aid dispersion into the polymer, for example coated with a surfactant such as oleylamine oleic acid, or the like. The magnetic particles can further be coated with other materials such as silica or silver.

In another embodiment, and with reference to detail 1000 in FIG. 4C, the magnetic layer 300 is composed of a first magnetic layer 610, a second magnetic layer 620 spaced apart, for example, uniformly spaced apart from the first magnetic layer 610, and a dielectric reinforcement layer 630 disposed between and in intimate contact with the first magnetic layer 610 and the second magnetic layer 620. As used herein, uniformly spaced apart means that the spacing inbetween the first dielectric layer and the second dielectric layer is constant throughout the substrate, for example, the spacing at each location can vary within 5%, or within 1% of an average spacing value. The dielectric reinforcement layer 630 may be glass, fibrous glass cloth, a reinforcing polymer layer, a fiber-reinforced polymer layer, or any other dielectric layer having a structural integrity suitable for a purpose disclosed herein. In an embodiment, each of the first magnetic layer 610 and the second magnetic layer 620 are made of thin film ferrite.

In an embodiment, the dielectric reinforcement layer 630 is fibrous as described in FIG. 4A, and first magnetic layer 610, a second magnetic layer 620 coat the individual fibers or the cloth. The fibrous dielectric reinforcing layer can comprise a non-woven or woven, thermally stable web of fibers, for example glass fibers (such as E, S, and D glass fibers), high temperature polymer fibers (e.g., polyetherimide, polysulfone, polyether ketone, polyester, or liquid crystal polymer fibers such as VECTRAN™ commercially available from Kuraray), or a combination comprising at least one of the foregoing. The continuous or fibrous dielectric reinforcement layer 630 can be coated by methods known in the art, for example by chemical vapor deposition, electron beam deposition, and the like.

In an embodiment, and with reference to detail 1000 in FIG. 4D, the first dielectric layer 100 is disposed in direct contact with and forms a layer 102 on one side 302 of the magnetic layer 300, and the second dielectric layer 200 is disposed in direct contact with and forms a layer 202 on an opposing side 304 of the magnetic layer 300. Such layers 102, 202 may be formed where the magnetic layer 300 is made from a solid, cured, or non-impregnable magnetic material, and the first and second dielectric layers 100, 200 are made from a flowable thermoplastic or thermoset polymer that is flowably distributed over the magnetic layer 300 (prior to curing if thermosetting), or is laid over and chemically, thermally or mechanically bonded to the magnetic layer 300 (prior to full curing, or post curing if thermosetting).

In an embodiment, and with reference to detail 1000 in FIG. 4E, the first dielectric layer 100 partially impregnates 104 one side 302 of the magnetic layer 300, and the second dielectric layer 200 partially impregnates 204 and opposing side 304 of the magnetic layer 300. Such partial impregnation 104, 204 may be formed where the magnetic layer 300 is made of a impregnable material, such as the aforementioned fibrous magnetic layer 400, for example, and the first and second dielectric layers 100, 200 are made from a flowable thermoplastic or thermosetting polymer that is flowably distributed over the magnetic layer 300 (prior to curing if thermosetting).

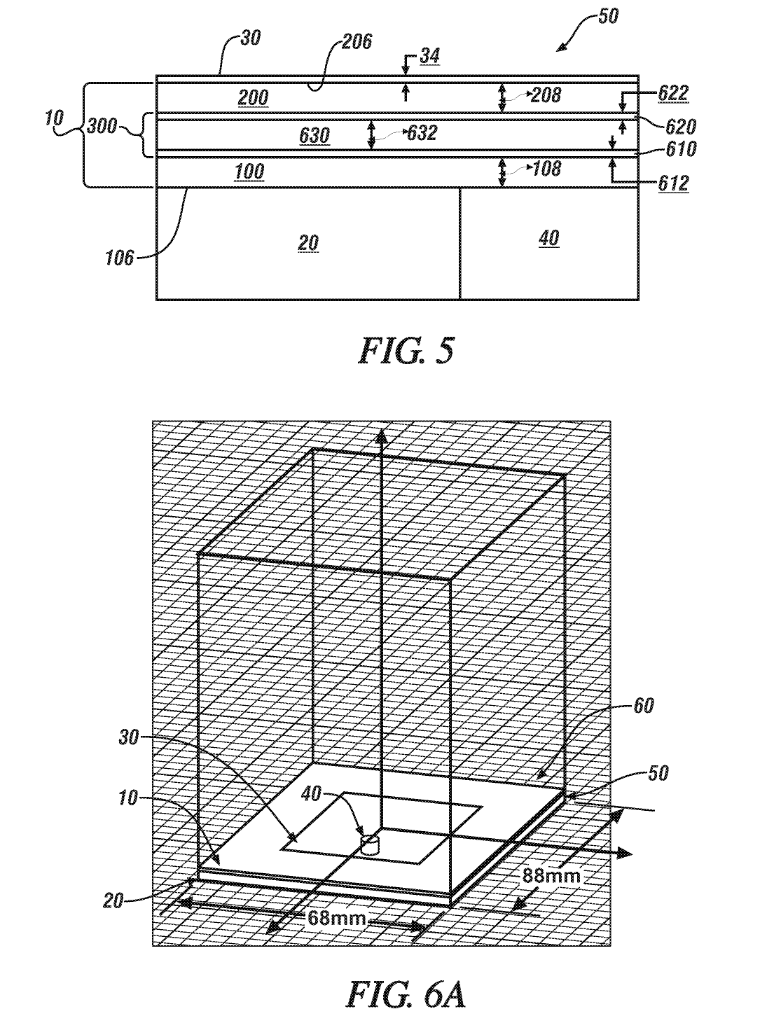

Reference is now made to FIG. 5, which depicts a portion of a magneto-dielectric substrate 10 similar to that depicted in FIG. 4C, but with a conductive ground layer 20 disposed on an outer surface 106 of the first dielectric layer 100, and a conductive element 30 disposed on an outer surface 206 of the second dielectric layer 200, where the conductive element 30 is spaced apart from the conductive ground layer 20. In an embodiment, the conductive ground layer 20 and the conductive element 30 are made from a conductive metal such as copper, and collectively the magneto-dielectric substrate 10, the ground layer 20, and the conductive element 30, may be fabricated as a laminate and referred to as a “copper clad circuit laminate” 50. In an embodiment, a signal line 40, which may be a central signal conductor of a coaxial cable, a feeder strip, or a micro-strip, for example, is disposed in signal communication with the conductive element 30. In an embodiment where a coaxial cable is provided having a ground sheath disposed around the central signal line, the ground sheath is disposed in electrical ground communication with the conductive ground layer 20.

To provide a magneto-dielectric substrate 10, and a copper clad circuit laminate 50, having certain and desirable electro-magnetic properties, the components of the copper clad laminate 50 are fabricated having certain dimensions relative to each other, which will now be described with reference to FIG. 5, but may also be applicable to other embodiment depicted in the several other figures provided herewith.

In an embodiment, the first dielectric layer 100 has a first thickness 108, and the second dielectric layer 200 has a second thickness 208 that is substantially equal in thickness to the first thickness 108. By forming the magneto-dielectric substrate 10 with first and second dielectric layers 100, 200 having substantially equal thicknesses, the magnetic layer 300 will be centrally disposed within the laminate, and a copper clad laminate 50 made with such a magneto-dielectric substrate 10 will concentrate a resulting magnetic field plane, which results from an electric field being established between the patch 30 and the ground plane 20 (discussed further below), in the central region of the magneto-dielectric substrate 10, which has been found to produce improved signal bandwidth over prior art devices (discussed further below). However, while it may be preferred to centrally position the magnetic layer(s) 300, 610, 620 in the magneto-dielectric substrate 10 since this is where there will be the highest concentration of the patch antenna magnetic field, it will be appreciated that the layers can be placed anywhere inside the patch in a manner suitable for a purpose disclosed herein. Furthermore, an embodiment may include an arrangement where the magnetic layers are designed to have structure that follows exactly the structure of the magnetic field pattern, where discontinuities in the magnetic layers would serve to suppress propagating modes in the antenna design.

In an embodiment, the first magnetic layer 610 has a first-magnetic-layer thickness 612, the second magnetic layer 620 has a second-magnetic-layer thickness 622, and the dielectric reinforcement layer 630 has a reinforcement-layer thickness 632. In an embodiment, a ratio of the reinforcement-layer thickness 632 to the first-magnetic-layer thickness 612 is equal to or greater than 25, and a ratio of the reinforcement-layer thickness 632 to the second-magnetic-layer thickness 622 is equal to or greater than 25.

While reference is made herein to a magnetic layer 300, which may be a single magnetic layer, or composed of a first magnetic layer 610 and a second magnetic layer 620, it will be appreciated that the number of layers that form the magnetic layer 300 is not limited to just one or two layers, but may be any number layers suitable for a purpose disclosed herein.

Example thicknesses for the aforementioned thicknesses that comply with the aforementioned ratios are: 0.25 millimeters for the first thickness 108 of the first dielectric layer 100; 0.25 millimeters for the second thickness 208 of the second dielectric layer 200; 0.25 millimeters for the reinforcement-layer thickness 632 of the dielectric reinforcement layer 630; 10 microns for the first-magnetic-layer thickness 612 of the first magnetic layer 610; and, 10 microns for the second-magnetic-layer thickness 622 of the second magnetic layer 620.

In an embodiment, the conductive element 30 has a thickness 34 of 40 microns.

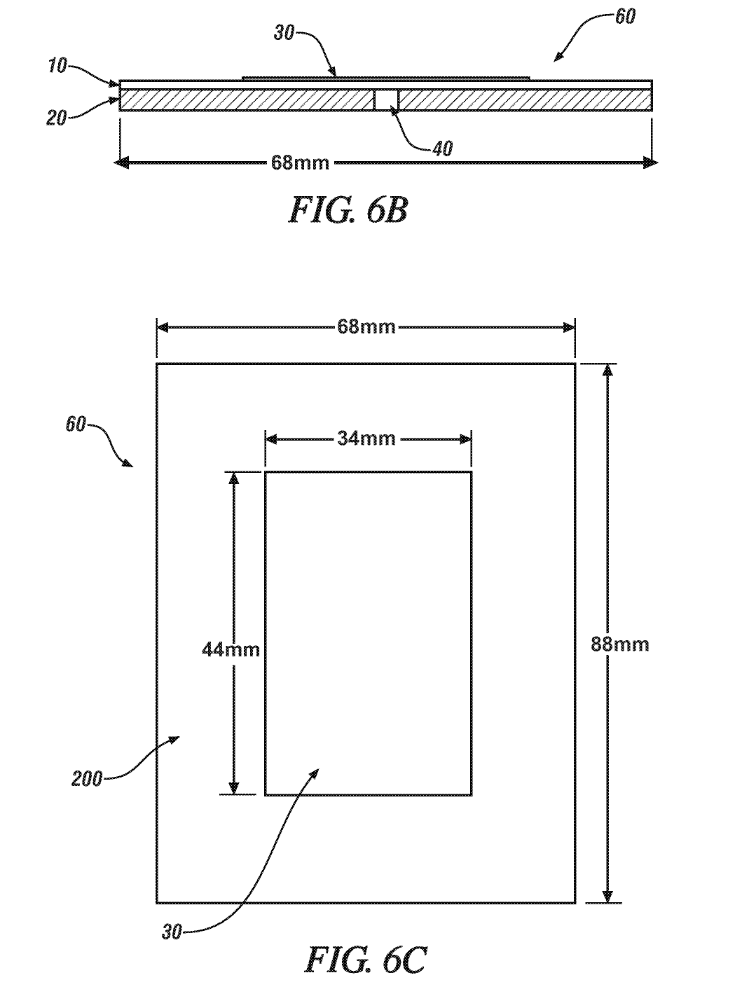

Reference is now made to FIG. 5, FIG. 6A, FIG. 6B and FIG. 6C, depicting various views of the copper clad laminate 50 (magneto-dielectric substrate 10, ground layer 20, and conductive element 30) as herein described, employed in as an antenna 60. In an embodiment, the first dielectric layer 100 has outer dimensions (68 mm by 88 mm, for example) that define a first footprint, the second dielectric layer 200 has outer dimensions (68 mm by 88 mm, for example) that define a second footprint substantially equal in size to the first footprint, the magnetic layer 300 has outer dimensions (68 mm by 88 mm, for example) that define a third footprint substantially equal in size to the first and second footprints, the conductive ground layer 20 has outer dimensions (68 mm by 88 mm, for example) that define a fourth footprint substantially equal in size to the first footprint, and the conductive element 30 has outer dimensions (34 mm by 44 mm, for example) that define a fifth footprint that is smaller in size than the second footprint. In an embodiment, and with reference to the above noted footprint dimensions, a ratio of an area of the fifth footprint (conductive element 30) to an area of the second footprint (second dielectric layer 200) is equal to or less than 0.3, and in another embodiment is equal to or less than 0.25. In an embodiment, the fifth footprint of the conductive element 30 is centrally disposed on the second footprint of the second dielectric layer 200.

In an embodiment, the conductive element 30 of the copper clad laminate 50 is patterned (see FIG. 3 for example) to generate a desired shape for use as an antenna.

The dielectric materials for use in the dielectric layers are selected to provide the desired electrical and mechanical properties, and generally comprise a thermoplastic or thermosetting polymer matrix and a dielectric filler. The dielectric layer can comprise, based on the volume of the dielectric layer, 30 to 99 volume percent (vol %) of a polymer matrix, and 0 to 70 vol %, specifically, 1 to 70 vol %, more specifically, 5 to 50 vol % of a filler. The polymer and the filler are selected to provide a dielectric layer having a dielectric constant of less than 3.5 and a dissipation factor of less than 0.006, specifically, less than or equal to 0.0035 at 10 gigaHertz (GHz). The dissipation factor can be measured by the IPC-TM-650 X-band strip line method or by the Split Resonator method.

The dielectric layer comprises a low polarity, low dielectric constant, and low loss polymer, which can be either thermosetting or thermoplastic. The polymer can comprise 1,2-polybutadiene (PBD), polyisoprene, polybutadiene-polyisoprene copolymers, polyetherimide (PEI), fluoropolymers such as polytetrafluoroethylene (PTFE), polyimide, polyetheretherketone (PEEK), polyamidimide, polyethylene terephthalate (PET), polyethylene naphthalate, polycyclohexylene terephthalate, polybutadiene-polyisoprene copolymers, polyphenylene ethers, those based on allylated polyphenylene ethers, or a combination comprising at least one of the foregoing. Combinations of low polarity s with higher polarity s can also be used, non-limiting examples including epoxy and poly(phenylene ether), epoxy and poly(ether imide), cyanate ester and poly(phenylene ether), and 1,2-polybutadiene and polyethylene.

Fluoropolymers include fluorinated homopolymers, e.g., PTFE and polychlorotrifluoroethylene (PCTFE), and fluorinated copolymers, e.g. copolymers of tetrafluoroethylene or chlorotrifluoroethylene with a monomer such as hexafluoropropylene and perfluoroalkylvinylethers vinylidene fluoride, vinyl fluoride, ethylene, or a combination comprising at least one of the foregoing, The fluoropolymer can comprise a combination of different at least one these fluoropolymers.

The polymer matrix can comprise thermosetting polybutadiene and/or polyisoprene. As used herein, the term “thermosetting polybutadiene and/or polyisoprene” includes homopolymers and copolymers comprising units derived from butadiene, isoprene, or mixtures thereof. Units derived from other copolymerizable monomers can also be present in the polymer, for example, in the form of grafts. Exemplary copolymerizable monomers include, but are not limited to, vinylaromatic monomers, for example substituted and unsubstituted monovinylaromatic monomers such as styrene, 3-methylstyrene, 3,5-diethylstyrene, 4-n-propylstyrene, alpha-methylstyrene, alpha-methyl vinyltoluene, para-hydroxystyrene, para-methoxystyrene, alpha-chlorostyrene, alpha-bromostyrene, dichlorostyrene, dibromostyrene, tetra-chlorostyrene, and the like; and substituted and unsubstituted divinylaromatic monomers such as divinylbenzene, divinyltoluene, and the like. Combinations comprising at least one of the foregoing copolymerizable monomers can also be used. Exemplary thermosetting polybutadiene and/or polyisoprene s include, but are not limited to, butadiene homopolymers, isoprene homopolymers, butadiene-vinylaromatic copolymers such as butadiene-styrene, isoprene-vinylaromatic copolymers such as isoprene-styrene copolymers, and the like.

The thermosetting polybutadiene and/or polyisoprenes can also be modified. For example, the polymers can be hydroxyl-terminated, methacrylate-terminated, carboxylate-terminated, s or the like. Post-reacted polymers can be used, such as epoxy-, maleic anhydride-, or urethane-modified polymers of butadiene or isoprene polymers. The polymers can also be crosslinked, for example by divinylaromatic compounds such as divinyl benzene, e.g., a polybutadiene-styrene crosslinked with divinyl benzene. Exemplary s are broadly classified as “polybutadienes” by their manufacturers, for example, Nippon Soda Co., Tokyo, Japan, and Cray Valley Hydrocarbon Specialty Chemicals, Exton, Pa. Mixtures of s can also be used, for example, a mixture of a polybutadiene homopolymer and a poly(butadiene-isoprene) copolymer. Combinations comprising a syndiotactic polybutadiene can also be useful.

The thermosetting polybutadiene and/or polyisoprene can be liquid or solid at room temperature. The liquid polymer can have a number average molecular weight (Mn) of greater than or equal to 5,000 g/mol. The liquid polymer can have an Mn of less than 5,000 g/mol, specifically, 1,000 to 3,000 g/mol. Thermosetting polybutadiene and/or polyisoprenes having at least 90 wt % 1,2 addition, which can exhibit greater crosslink density upon cure due to the large number of pendent vinyl groups available for crosslinking.

The polybutadiene and/or polyisoprene can be present in the polymer composition in an amount of up to 100 wt %, specifically, up to 75 wt % with respect to the total polymer matrix composition, more specifically, 10 to 70 wt %, even more specifically, 20 to 60 or 70 wt %, based on the total polymer matrix composition.

Other polymers that can co-cure with the thermosetting polybutadiene and/or polyisoprene s can be added for specific property or processing modifications. For example, in order to improve the stability of the dielectric strength and mechanical properties of the electrical substrate material over time, a lower molecular weight ethylene-propylene elastomer can be used in the systems. An ethylene-propylene elastomer as used herein is a copolymer, terpolymer, or other polymer comprising primarily ethylene and propylene. Ethylene-propylene elastomers can be further classified as EPM copolymers (i.e., copolymers of ethylene and propylene monomers) or EPDM terpolymers (i.e., terpolymers of ethylene, propylene, and diene monomers). Ethylene-propylene-diene terpolymer rubbers, in particular, have saturated main chains, with unsaturation available off the main chain for facile cross-linking. Liquid ethylene-propylene-diene terpolymer rubbers, in which the diene is dicyclopentadiene, can be used.

The molecular weights of the ethylene-propylene rubbers can be less than 10,000 g/mol viscosity average molecular weight (My). The ethylene-propylene rubber can include an ethylene-propylene rubber having an My of 7,200 g/mol, which is available from Lion Copolymer, Baton Rouge, La., under the trade name TRILENE™ CP80; a liquid ethylene-propylene-dicyclopentadiene terpolymer rubbers having an My of 7,000 g/mol, which is available from Lion Copolymer under the trade name of TRILENE™ 65; and a liquid ethylene-propylene-ethylidene norbornene terpolymer having an My of 7,500 g/mol, which is available from Lion Copolymer under the name TRILENE™ 67.

The ethylene-propylene rubber can be present in an amount effective to maintain the stability of the properties of the substrate material over time, in particular the dielectric strength and mechanical properties. Typically, such amounts are up to 20 wt % with respect to the total weight of the polymer matrix composition, specifically, 4 to 20 wt %, more specifically, 6 to 12 wt %.

Another type of co-curable polymer is an unsaturated polybutadiene- or polyisoprene-containing elastomer. This component can be a random or block copolymer of primarily 1,3-addition butadiene or isoprene with an ethylenically unsaturated monomer, for example, a vinylaromatic compound such as styrene or alpha-methyl styrene, an acrylate or methacrylate such a methyl methacrylate, or acrylonitrile. The elastomer can be a solid, thermoplastic elastomer comprising a linear or graft-type block copolymer having a polybutadiene or polyisoprene block and a thermoplastic block that can be derived from a monovinylaromatic monomer such as styrene or alpha-methyl styrene. Block copolymers of this type include styrene-butadiene-styrene triblock copolymers, for example, those available from Dexco Polymers, Houston, Tex. under the trade name VECTOR 8508M™, from Enichem Elastomers America, Houston, Tex. under the trade name SOL-T-6302™, and those from Dynasol Elastomers under the trade name CALPRENE™ 401; and styrene-butadiene diblock copolymers and mixed triblock and diblock copolymers containing styrene and butadiene, for example, those available from Kraton Polymers (Houston, Tex.) under the trade name KRATON D1118. KRATON D1118 is a mixed diblock/triblock styrene and butadiene containing copolymer that contains 33 wt % styrene.

The optional polybutadiene- or polyisoprene-containing elastomer can further comprise a second block copolymer similar to that described above, except that the polybutadiene or polyisoprene block is hydrogenated, thereby forming a polyethylene block (in the case of polybutadiene) or an ethylene-propylene copolymer block (in the case of polyisoprene). When used in conjunction with the above-described copolymer, materials with greater toughness can be produced. An exemplary second block copolymer of this type is KRATON GX1855 (commercially available from Kraton Polymers, which is believed to be a mixture of a styrene-high 1,2-butadiene-styrene block copolymer and a styrene-(ethylene-propylene)-styrene block copolymer.

The unsaturated polybutadiene- or polyisoprene-containing elastomer component can be present in the polymer matrix composition in an amount of 2 to 60 wt % with respect to the total weight of the polymer matrix composition, specifically, 5 to 50 wt %, more specifically, 10 to 40 or 50 wt %.

Still other co-curable polymers that can be added for specific property or processing modifications include, but are not limited to, homopolymers or copolymers of ethylene such as polyethylene and ethylene oxide copolymers; natural rubber; norbornene polymers such as polydicyclopentadiene; hydrogenated styrene-isoprene-styrene copolymers and butadiene-acrylonitrile copolymers; unsaturated polyesters; and the like. Levels of these copolymers are generally less than 50 wt % of the total polymer in the polymer matrix composition.

Free radical-curable monomers can also be added for specific property or processing modifications, for example to increase the crosslink density of the system after cure. Exemplary monomers that can be suitable crosslinking agents include, for example, di, tri-, or higher ethylenically unsaturated monomers such as divinyl benzene, triallyl cyanurate, diallyl phthalate, and multifunctional acrylate monomers (e.g., SARTOMER™ polymers available from Sartomer USA, Newtown Square, Pa.), or combinations thereof, all of which are commercially available. The crosslinking agent, when used, can be present in the polymer matrix composition in an amount of up to 20 wt %, specifically, 1 to 15 wt %, based on the total weight of the total polymer in the polymer matrix composition.

A curing agent can be added to the polymer matrix composition to accelerate the curing reaction of polyenes having olefinic reactive sites. Curing agents can comprise organic peroxides, for example, dicumyl peroxide, t-butyl perbenzoate, 2,5-dimethyl-2,5-di(t-butyl peroxy)hexane, α,α-di-bis(t-butyl peroxy)diisopropylbenzene, 2,5-dimethyl-2,5-di(t-butyl peroxy) hexyne-3, or a combination comprising at least one of the foregoing. Carbon-carbon initiators, for example, 2,3-dimethyl-2,3 diphenylbutane can be used. Curing agents or initiators can be used alone or in combination. The amount of curing agent can be 1.5 to 10 wt % based on the total weight of the polymer in the polymer matrix composition.

In some embodiments, the polybutadiene or polyisoprene polymer is carboxy-functionalized. Functionalization can be accomplished using a polyfunctional compound having in the molecule both (i) a carbon-carbon double bond or a carbon-carbon triple bond, and (ii) at least one of a carboxy group, including a carboxylic acid, anhydride, amide, ester, or acid halide. A specific carboxy group is a carboxylic acid or ester. Examples of polyfunctional compounds that can provide a carboxylic acid functional group include maleic acid, maleic anhydride, fumaric acid, and citric acid. In particular, polybutadienes adducted with maleic anhydride can be used in the thermosetting composition. Suitable maleinized polybutadiene polymers are commercially available, for example from Cray Valley under the trade names RICON 130MA8, RICON 130MA13, RICON 130MA20, RICON 131MA5, RICON 131MA10, RICON 131MA17, RICON 131MA20, and RICON 156MA17. Suitable maleinized polybutadiene-styrene copolymers are commercially available, for example, from Sartomer under the trade names RICON 184MA6. RICON 184MA6 is a butadiene-styrene copolymer adducted with maleic anhydride having styrene content of 17 to 27 wt % and Mn of 9,900 g/mol.

The relative amounts of the various polymers in the polymer matrix composition, for example, the polybutadiene or polyisoprene polymer and other polymers, can depend on the particular conductive metal layer used, the desired properties of the circuit materials and copper clad laminates, and like considerations. For example, use of a poly(arylene ether) can provide increased bond strength to the conductive metal layer, for example, copper. Use of a polybutadiene or polyisoprene polymer can increase high temperature resistance of the laminates, for example, when these polymers are carboxy-functionalized. Use of an elastomeric block copolymer can function to compatibilize the components of the polymer matrix material. Determination of the appropriate quantities of each component can be done without undue experimentation, depending on the desired properties for a particular application.

At least one dielectric layer can further include a particulate dielectric filler selected to adjust the dielectric constant, dissipation factor, coefficient of thermal expansion, and other properties of the dielectric layer. The dielectric filler can comprise, for example, titanium dioxide (rutile and anatase), barium titanate, strontium titanate, silica (including fused amorphous silica), corundum, wollastonite, Ba₂Ti₉O₂₀, solid glass spheres, synthetic glass or ceramic hollow spheres, quartz, boron nitride, aluminum nitride, silicon carbide, beryllia, alumina, alumina trihydrate, magnesia, mica, talcs, nanoclays, magnesium hydroxide, or a combination comprising at least one of the foregoing. A single secondary filler, or a combination of secondary fillers, can be used to provide a desired balance of properties.

Optionally, the fillers can be surface treated with a silicon-containing coating, for example, an organofunctional alkoxy silane coupling agent. A zirconate or titanate coupling agent can be used. Such coupling agents can improve the dispersion of the filler in the polymeric matrix and reduce water absorption of the finished composite circuit substrate. The filler component can comprise 5 to 50 vol % of the microspheres and 70 to 30 vol % of fused amorphous silica as secondary filler based on the weight of the filler.

The dielectric layer can also optionally contain a flame retardant useful for making the layer resistant to flame. These flame retardant can be halogenated or unhalogenated. The flame retardant can be present in in the dielectric layer in an amount of 0 to 30 vol % based on the volume of the dielectric layer.

In an embodiment, the flame retardant is inorganic and is present in the form of particles. An exemplary inorganic flame retardant is a metal hydrate, having, for example, a volume average particle diameter of 1 nm to 500 nm, preferably 1 to 200 nm, or 5 to 200 nm, or 10 to 200 nm; alternatively the volume average particle diameter is 500 nm to 15 micrometer, for example 1 to 5 micrometer. The metal hydrate is a hydrate of a metal such as Mg, Ca, Al, Fe, Zn, Ba, Cu, Ni, or a combination comprising at least one of the foregoing. Hydrates of Mg, Al, or Ca are particularly preferred, for example aluminum hydroxide, magnesium hydroxide, calcium hydroxide, iron hydroxide, zinc hydroxide, copper hydroxide and nickel hydroxide; and hydrates of calcium aluminate, gypsum dihydrate, zinc borate and barium metaborate. Composites of these hydrates can be used, for example a hydrate containing Mg and one or more of Ca, Al, Fe, Zn, Ba, Cu and A preferred composite metal hydrate has the formula MgMx. (OH)_{y} wherein M is Ca, Al, Fe, Zn, Ba, Cu or Ni, x is 0.1 to 10, and y is from 2 to 32. The flame retardant particles can be coated or otherwise treated to improve dispersion and other properties.

Organic flame retardants can be used, alternatively or in addition to the inorganic flame retardants. Examples of inorganic flame retardants include melamine cyanurate, fine particle size melamine polyphosphate, various other phosphorus-containing compounds such as aromatic phosphinates, diphosphinates, phosphonates, and phosphates, certain polysilsesquioxanes, siloxanes, and halogenated compounds such as hexachloroendomethylenetetrahydrophthalic acid (HET acid), tetrabromophthalic acid and dibromoneopentyl glycol A flame retardant (such as a bromine-containing flame retardant) can be present in an amount of 20 phr (parts per hundred parts of resin) to 60 phr, specifically, 30 to 45 phr. Examples of brominated flame retardants include Saytex BT93W (ethylene bistetrabromophthalimide), Saytex 120 (tetradecabromodiphenoxy benzene), and Saytex 102 (decabromodiphenyl oxide). The flame retardant can be used in combination with a synergist, for example a halogenated flame retardant can be used in combination with a synergists such as antimony trioxide, and a phosphorus-containing flame retardant can be used in combination with a nitrogen-containing compound such as melamine.

Useful conductive layers for the formation of the circuit materials include, for example, stainless steel, copper, gold, silver, aluminum, zinc, tin, lead, transition metals, and alloys comprising at least one of the foregoing. There are no particular limitations regarding the thickness of the conductive layer, nor are there any limitations as to the shape, size, or texture of the surface of the conductive layer. The conductive layer can have a thickness of 3 to 200 micrometers, specifically, 9 to 180 micrometers. When two or more conductive layers are present, the thickness of the two layers can be the same or different. In an exemplary embodiment, the conductive layer is a copper layer. Suitable conductive layers include a thin layer of a conductive metal such as a copper foil presently used in the formation of circuits, for example, electrodeposited copper foils. The copper foil can have a route mean squared (RMS) roughness of less than or equal to 2 micrometers, specifically, less than or equal to 0.7 micrometers, where roughness is measured using a Veeco Instruments WYCO Optical Profiler, using the method of white light interferometry. The various materials and articles used herein, including the magnetic reinforcing layers, dielectric layers, magneto-dielectric substrates, circuit materials, and electronic devices comprising the circuit materials can be formed by methods generally known in the art.

The conductive layer can be applied by placing the conductive layer in the mold prior to molding, by laminating the conductive layer onto the magneto-dielectric substrate, by direct laser structuring, or by adhering the conductive layer to the substrate via an adhesive layer. For example, a laminated substrate can comprise an optional polyfluorocarbon film that can be located in between the conductive layer and the magneto-dielectric substrate, and a layer of microglass reinforced fluorocarbon polymer that can be located in between the polyfluorocarbon film and the conductive layer. The layer of microglass reinforced fluorocarbon polymer can increase the adhesion of the conductive layer to the magneto-dielectric substrate. The microglass can be present in an amount of 4 to 30 wt % based on the total weight of the layer. The microglass can have a longest length scale of less than or equal to 900 micrometers, specifically, less than or equal to 500 micrometers. The microglass can be microglass of the type as commercially available by Johns-Manville Corporation of Denver, Colo. The polyfluorocarbon film comprises a fluoropolymer (such as polytetrafluoroethylene (PTFE), a fluorinated ethylene-propylene copolymer (such as Teflon FEP), and a copolymer having a tetrafluoroethylene backbone with a fully fluorinated alkoxy side chain (such as Teflon PFA)).

The conductive layer can be applied by laser direct structuring. Here, the magneto-dielectric substrate can comprise a laser direct structuring additive, a laser is used to irradiate the surface of the substrate, forming a track of the laser direct structuring additive, and a conductive metal is applied to the track. The laser direct structuring additive can comprise a metal oxide particle (such as titanium oxide and copper chromium oxide). The laser direct structuring additive can comprise a spinel-based inorganic metal oxide particle, such as spinel copper. The metal oxide particle can be coated, for example, with a composition comprising tin and antimony (for example, 50 to 99 wt % of tin and 1 to 50 wt % of antimony, based on the total weight of the coating). The laser direct structuring additive can comprise 2 to 20 parts of the additive based on 100 parts of the respective composition. The irradiating can be performed with a YAG laser having a wavelength of 1064 nanometers under a output power of 10 Watts, a frequency of 80 kHz, and a rate of 3 meters per second. The conductive metal can be applied using a plating process in an electroless plating bath comprising, for example, copper.

Alternatively, the conductive layer can be applied by adhesively applying the conductive layer. In an embodiment, the conductive layer is the circuit (the metallized layer of another circuit), for example, a flex circuit. For example, an adhesion layer can be disposed between one or both of the conductive layer(s) and the substrate. The adhesion layer can comprise a poly(arylene ether); and a carboxy-functionalized polybutadiene or polyisoprene polymer comprising butadiene, isoprene, or butadiene and isoprene units, and zero to less than or equal to 50 wt % of co-curable monomer units; wherein the composition of the adhesive layer is not the same as the composition of the substrate layer. The adhesive layer can be present in an amount of 2 to 15 grams per square meter. The poly(arylene ether) can comprise a carboxy-functionalized poly(arylene ether). The poly(arylene ether) can be the reaction product of a poly(arylene ether) and a cyclic anhydride, or the reaction product of a poly(arylene ether) and maleic anhydride. The carboxy-functionalized polybutadiene or polyisoprene polymer can be a carboxy-functionalized butadiene-styrene copolymer. The carboxy-functionalized polybutadiene or polyisoprene polymer can be the reaction product of a polybutadiene or polyisoprene polymer and a cyclic anhydride. The carboxy-functionalized polybutadiene or polyisoprene polymer can be a maleinized polybutadiene-styrene or maleinized polyisoprene-styrene copolymer. Other methods known in the art can be used to apply the conductive layer where admitted by the particular materials and form of the circuit material, for example, electrodeposition, chemical vapor deposition, lamination, or the like.

Where the magnetic reinforcing layer comprises a dielectric reinforcement, the reinforcing magnetic layer can be formed by coating, for example, by chemical vapor deposition, electron beam deposition, laminating, dip coating, spray coating, reverse roll coating, knife-over-roll, knife-over-plate, metering rod coating, flow coating, and the like a dielectric reinforcing layer with the magnetic layer, for example, with a macroscopically continuous magnetic layer or with the magnetic particles. The magnetic layer can be applied to the dielectric reinforcing layer as a solution comprising the magnetic layer or a precursor thereof and a suitable solvent. The magnetic layer can be applied to both sides of the dielectric reinforcing layer in the same or different manners. A thickness of the first and second magnetic layer independently can be 1 to 5 micrometers. Alternatively, where the dielectric reinforcing layer is fibrous, the fibers can be impregnated with the magnetic layer by the above methods.

In another embodiment, the magnetic particles can be added to the dielectric reinforcing layer during formation of the dielectric reinforcing layer. For example, a melted or dissolved liquid mixture comprising the dielectric reinforcing layer and the magnetic particles can be spun into fibers to form the magnetic reinforcing layer.

The dielectric layer can be formed by casting directly onto the magnetic layer or a dielectric layer can be produced that can be laminated onto the magnetic layer. The dielectric layer can be produced based on the polymer selected. For example, where the polymer comprises a fluoropolymer such as PTFE, the polymer can be mixed with a first carrier liquid. The mixture can comprise a dispersion of polymeric particles in the first carrier liquid, i.e. an emulsion, of liquid droplets of the polymer or of a monomeric or oligomeric precursor of the polymer in the first carrier liquid, or a solution of the polymer in the first carrier liquid. If the polymer is liquid, then no first carrier liquid may be necessary.

The choice of the first carrier liquid, if present, can be based on the particular polymeric and the form in which the polymeric is to be introduced to the dielectric layer. If it is desired to introduce the polymeric as a solution, a solvent for the particular polymer is chosen as the carrier liquid, e.g., N-methyl pyrrolidone (NMP) would be a suitable carrier liquid for a solution of a polyimide. If it is desired to introduce the polymer as a dispersion, then the carrier liquid can comprise a liquid in which the is not soluble, e.g., water would be a suitable carrier liquid for a dispersion of PTFE particles and would be a suitable carrier liquid for an emulsion of polyamic acid or an emulsion of butadiene monomer.

The dielectric filler component can optionally be dispersed in a second carrier liquid, or mixed with the first carrier liquid (or liquid polymer where no first carrier is used). The second carrier liquid can be the same liquid or can be a liquid other than the first carrier liquid that is miscible with the first carrier liquid. For example, if the first carrier liquid is water, the second carrier liquid can comprise water or an alcohol. The second carrier liquid can comprise water.

The filler dispersion can comprise a surfactant in an amount effective to modify the surface tension of the second carrier liquid to enable the second carrier liquid to wet the borosilicate microspheres. Exemplary surfactant compounds include ionic surfactants and nonionic surfactants. TRITON X-100™, has been found to be an exemplary surfactant for use in aqueous filler dispersions. The filler dispersion can comprise 10 to 70 vol % of filler and 0.1 to 10 vol % of surfactant, with the remainder comprising the second carrier liquid.

The combination of the polymer and first carrier liquid and the filler dispersion in the second carrier liquid can be combined to form a casting mixture. In an embodiment, the casting mixture comprises 10 to 60 vol % of the combined polymer and filler and 40 to 90 vol % combined first and second carrier liquids. The relative amounts of the polymer and the filler component in the casting mixture can be selected to provide the desired amounts in the final composition as described below.

The viscosity of the casting mixture can be adjusted by the addition of a viscosity modifier, selected on the basis of its compatibility in a particular carrier liquid or mixture of carrier liquids, to retard separation, i.e. sedimentation or flotation, of the hollow sphere filler from the dielectric composite material and to provide a dielectric composite material having a viscosity compatible with conventional laminating equipment. Exemplary viscosity modifiers suitable for use in aqueous casting mixtures include, e.g., polyacrylic acid compounds, vegetable gums, and cellulose based compounds. Specific examples of suitable viscosity modifiers include polyacrylic acid, methyl cellulose, polyethyleneoxide, guar gum, locust bean gum, sodium carboxymethylcellulose, sodium alginate, and gum tragacanth. The viscosity of the viscosity-adjusted casting mixture can be further increased, i.e., beyond the minimum viscosity, on an application by application basis to adapt the dielectric composite material to the selected laminating technique. In an embodiment, the viscosity-adjusted casting mixture can exhibit a viscosity of 10 to 100,000 centipoise (cp); specifically, 100 cp and 10,000 cp measured at room temperature value.

Alternatively, the viscosity modifier can be omitted if the viscosity of the carrier liquid is sufficient to provide a casting mixture that does not separate during the time period of interest. Specifically, in the case of extremely small particles, e.g., particles having an equivalent spherical diameter less than 0.1 micrometers, the use of a viscosity modifier may not be necessary.

A layer of the viscosity-adjusted casting mixture can be cast onto the magnetic layer, or can be dip-coated. The casting can be achieved by, for example, dip coating, flow coating, reverse roll coating, knife-over-roll, knife-over-plate, metering rod coating, and the like.

The carrier liquid and processing aids, i.e., the surfactant and viscosity modifier, can be removed from the cast layer, for example, by evaporation and/or by thermal decomposition in order to consolidate a dielectric layer of the polymer and the filler comprising the microspheres.

The layer of the polymeric matrix material and filler component can be further heated to modify the physical properties of the layer, e.g., to sinter a thermoplastic or to cure and/or post cure a thermosetting.

In another method, a PTFE composite dielectric layer can be made by a paste extrusion and calendaring process.

In still another embodiment, the dielectric layer can be cast and then partially cured (“B-staged”). Such B-staged layers can be stored and used subsequently, e.g., in lamination processes.

The magneto-dielectric substrate can be formed by the methods described above. For example the dielectric layer can be cast directly onto the magnetic reinforcing layer, or the magnetic reinforcing layer can be coated, for example dip coated, spray coated, reverse roll coated, knife-over-roll, knife-over-plate, metering rod coated, flow coated, or the like with a solution or mixture comprising the dielectric polymer matrix composition, dielectric filler, and optional additives. Alternatively, in a lamination process, the magnetic reinforcing layer is placed between the first and second dielectric layers and laminated under heat and pressure. Where the magnetic reinforcing layer is fibrous, the dielectric layer flows into and impregnates the fibrous magnetic reinforcing layer. As described in additional detail below, and adhesive layer can be placed between the fibrous magnetic reinforcing layer and the first and second dielectric layers.

The single clad circuit material can be formed by adhering or laminating the conductive layer to the first or second dielectric layer. The double clad circuit material can be formed by casting or laminating the first and second dielectric layer onto the magnetic layer; and applying a first and a second conductive element to the first and second dielectric layer simultaneously or sequentially.

In a specific embodiment, the circuit material can be formed by a lamination process that entails placing the first and second dielectric layer and the magnetic layer between one or two sheets of coated or uncoated conductive layers (an adhesive layer can be disposed between at least one conductive layer and at least one dielectric substrate layer) to form a layered structure. Alternatively, if a fibrous magnetic reinforcing layer is used, the conductive layer can be in direct contact with the dielectric substrate layer or optional adhesive layer, specifically, without an intervening layer, wherein an optional adhesive layer can be less than or equal to 10 percent of the thickness of the total thickness of the total of the first and second dielectric layer. The layered structure can then be placed in a press, e.g., a vacuum press, under a pressure and temperature and for duration of time suitable to bond the layers and form a laminate. Lamination and curing can be by a one-step process, for example, using a vacuum press, or can be by a multi-step process. In a one-step process, for a PTFE, the layered structure can be placed in a press, brought up to laminating pressure (e.g., 150 to 400 pounds per square inch (psi)) and heated to laminating temperature (e.g., 260 to 390° C.). The laminating temperature and pressure are maintained for the desired soak time, i.e., 20 minutes, and thereafter cooled (while still under pressure) to less than or equal to 150° C.

An adhesion layer can be disposed between one or both of the conductive layer(s) and the dielectric layer. The adhesion layer can comprise a poly(arylene ether); and a carboxy-functionalized polybutadiene or polyisoprene polymer comprising butadiene, isoprene, or butadiene and isoprene units, and zero to less than or equal to 50 wt % of co-curable monomer units; wherein the composition of the adhesive layer is not the same as the composition of the dielectric substrate layer. The adhesive layer can be present in an amount of 2 to 15 grams per square meter. The poly(arylene ether) can comprise a carboxy-functionalized poly(arylene ether). The poly(arylene ether) can be the reaction product of a poly(arylene ether) and a cyclic anhydride or the reaction product of a poly(arylene ether) and maleic anhydride. The carboxy-functionalized polybutadiene or polyisoprene polymer can be a carboxy-functionalized butadiene-styrene copolymer. The carboxy-functionalized polybutadiene or polyisoprene polymer can be the reaction product of a polybutadiene or polyisoprene polymer and a cyclic anhydride. The carboxy-functionalized polybutadiene or polyisoprene polymer can be a maleinized polybutadiene-styrene or maleinized polyisoprene-styrene copolymer.

In an embodiment, a multiple-step process suitable for thermosetting materials such as polybutadiene and/or polyisoprene can comprise a peroxide cure step at temperatures of 150 to 200° C., and the partially cured stack can then be subjected to a high-energy electron beam irradiation cure (E-beam cure) or a high temperature cure step under an inert atmosphere. Use of a two-stage cure can impart an unusually high degree of cross-linking to the resulting laminate. The temperature used in the second stage can be 250 to 300° C., or the decomposition temperature of the polymer. This high temperature cure can be carried out in an oven but can also be performed in a press, namely as a continuation of the initial lamination and cure step. Particular lamination temperatures and pressures will depend upon the particular adhesive composition and the substrate composition, and are readily ascertainable by one of ordinary skill in the art without undue experimentation.

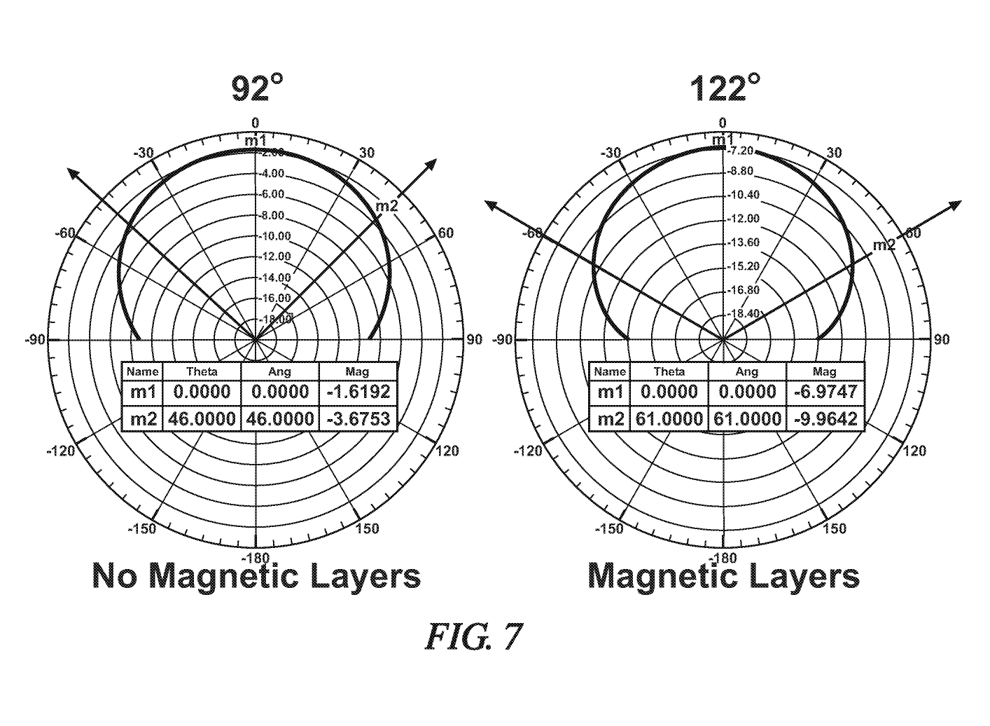

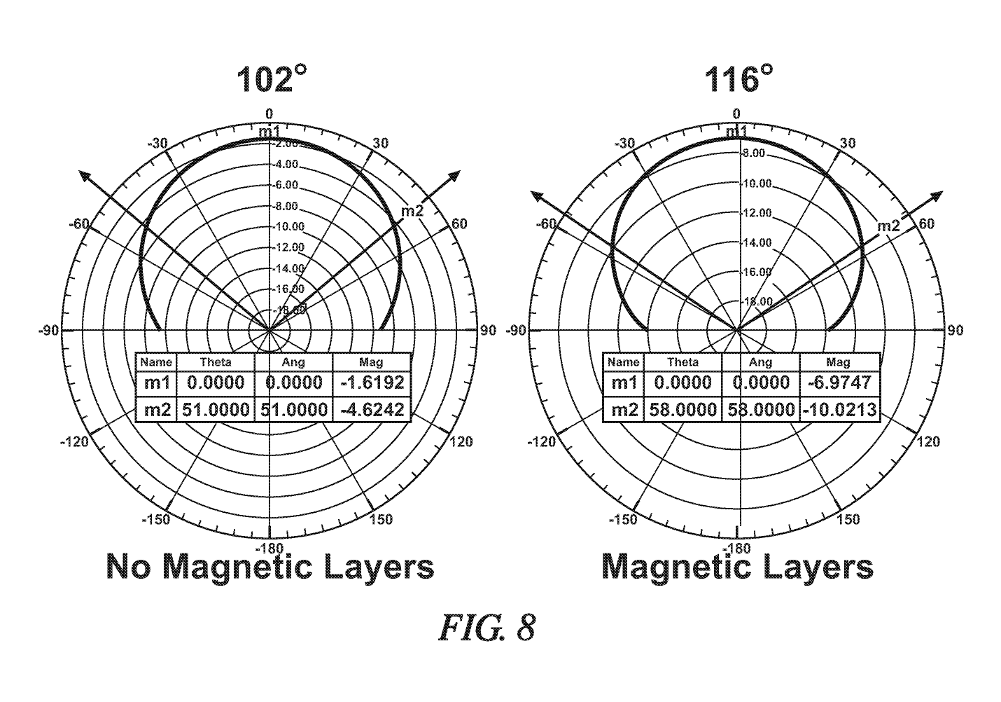

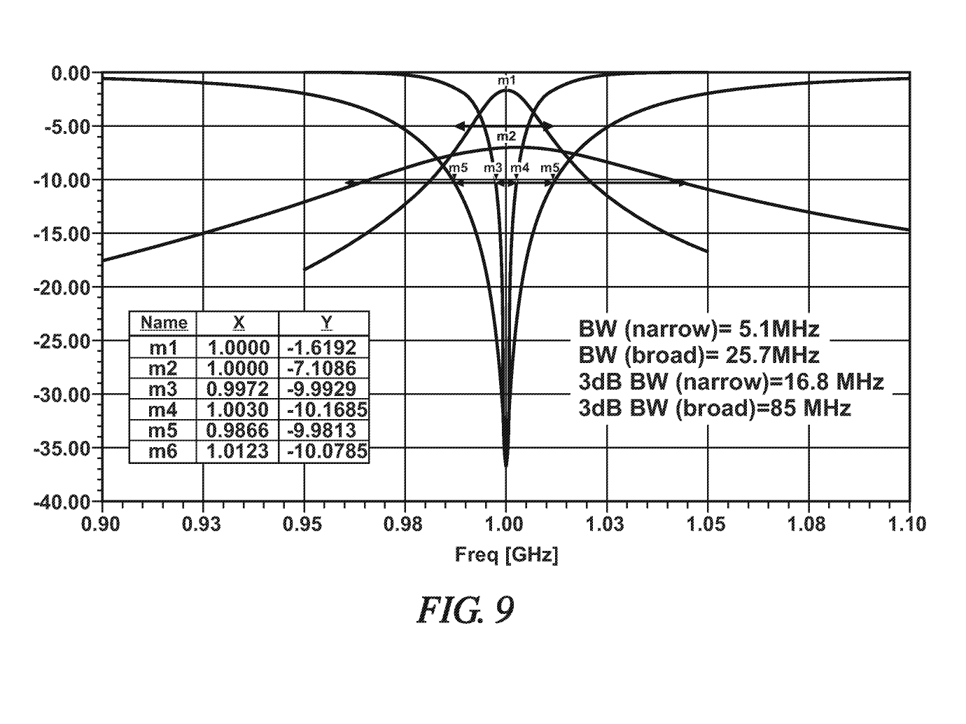

With regard to the foregoing, and with reference to FIGS. 7-8, it has been found that an antenna employing a magneto-dielectric substrate 10 as herein disclosed is suitable for providing an antenna 60 that is capable of radiating a 1 GHz signal into free space at a beam width of at least 122-degrees in an H-field plane, and at a beam width of at least 116-degrees in an E-field plane, with a peak gain of −6.97 dB, as compared to 92-degrees, 102-degrees, and −1.62 dB, respectively, for an antenna absent a magneto-dielectric substrate 10 as herein disclosed. And with reference to FIG. 9, it has been found that the above noted antenna has impedance and 3 dB gain bandwidths 5-6 times greater than a similar antenna not in accordance with an embodiment. FIGS. 7-9 illustrate the magnitude of improved beam widths and bandwidths of an antenna employing a copper clad circuit laminate 50 having a magneto-dielectric substrate 10 as herein disclosed, versus a copper clad circuit laminate absent a magneto-dielectric substrate 10 as herein disclosed.

An antenna 60 (see FIGS. 6A, 6B and 6C) capable of providing the beam widths and bandwidths depicted in FIGS. 7-9 employed the magneto-dielectric substrate 10 depicted in FIGS. 4C and 5, where: the first dielectric layer 100 and the second dielectric layer 200 were made from RO4000™ (Rogers Corporation) laminate having a dielectric constant of 3.55 and a loss tangent of 0.0027, and were both 0.25 mm thick; the magnetic layer 300 had a glass dielectric reinforcement layer 630 having a dielectric constant of 5.5 and a loss tangent of less than 0.001, with a thickness of 0.25 mm; the magnetic layer 300 further had a first magnetic layer 100 and a second magnetic layer 620 made from thin film ferrite having a permeability of 50 and a loss tangent of 0.05, and were both 10 microns thick; and, the conductive element 30 was made from 40 micron thick copper.

While certain embodiments of the magneto-dielectric substrate 10 and the antenna 60 have been described herein with reference to certain values for the thickness and permeability of the magnetic layer(s) 300, 610, 620, it will be appreciated that these certain values are example values only, and that other values for the respective thickness and permeability may be employed consistent with a purpose of the invention disclosed herein. Furthermore, while an antenna 60 has been described herein to have a certain size, and material characteristics, that was specifically chosen to resonate at 1 GHz, it will be appreciated that the scope of the invention is not so limited, and also encompasses antennas having different sizes to resonate at different frequencies while being suitable for a purpose disclosed herein.

The circuit assembly can be used in electronic devices such as inductors on electronic integrated circuit chips, electronic circuits, electronic packages, modules and housings, transducers, and UHF, VHF, and microwave antennas for a wide variety of applications, for example electric power applications, data storage, and microwave communication. The circuit assembly can be used in applications where an external direct current magnetic field is applied. Additionally, the magnetic layer(s) can be used with very good results (size and bandwidth) in all antenna designs over the frequency range 100-800 MHz. Furthermore, the application of an external magnetic field can “tune” the magnetic permeability of the magnetic layer(s) and, therefore, the resonant frequency of the patch.

“Layer” as used herein includes planar films, sheets, and the like as well as other three-dimensional non-planar forms. A layer can further be macroscopically continuous or non-continuous. Use of the terms “a” and “an” do not denote a limitation of quantity, but rather denote the presence of at least one of the referenced item. Ranges disclosed herein are inclusive of the recited endpoint and are independently combinable. “Combination” is inclusive of blends, mixtures, alloys, reaction products, and the like. Also, “combinations comprising at least one of the foregoing” means that the list is inclusive of each element individually, as well as combinations of two or more elements of the list, and combinations of at least one elements of the list with like elements not named. The terms “first,” “second,” and so forth, herein do not denote any order, quantity, or importance, but rather are used to distinguish one element from another. As used herein, the term “substantially equal” means that the two values of comparison are plus or minus 10% of each other, specifically, plus or minus 5% of each other, more specifically, plus or minus 1% of each other. “Or” means “and/or”.

As disclosed, some embodiments of the invention may include the advantage wherein when a 1 GHz signal is communicated to the conductive element via the signal line, the magneto-dielectric substrate is configured to and is capable of radiating the 1 GHz signal into free space at a beam width of at least 122-degrees in an H-field plane, and at a beam width of at least 116-degrees in an E-field plane.

The invention is further illustrated by the following Embodiments.

### Embodiment 1

A magneto-dielectric substrate, comprising: a first dielectric layer; a second dielectric layer spaced apart from the first dielectric layer; and at least one magnetic reinforcing layer disposed between and in intimate contact with the first dielectric layer and the second dielectric layer.

### Embodiment 2

The magneto-dielectric substrate of Embodiment 1, wherein the magnetic reinforcing layer comprises fibers, wherein the fibers are ferrite fibers, ferrite alloy fibers, cobalt fibers, cobalt alloy fibers, iron fibers, iron alloy fibers, nickel fibers, nickel alloy fibers, polymer fibers comprising particulate ferrite, a particulate ferrite alloy, particulate cobalt, a particulate cobalt alloy, particulate iron, a particulate iron alloy, particulate nickel, a particulate nickel alloy, or a combination comprising at least one of the foregoing, preferably hexaferrite, magnetite, or MFe₂O₄, wherein M is at least one of Co, Ni, Zn, V, or Mn.

### Embodiment 3

The magneto-dielectric substrate of Embodiment 1, wherein the magnetic reinforcing layer comprises polymer or glass fibers coated with ferrite, a ferrite alloy, cobalt, a cobalt alloy, iron, an iron alloy, nickel, a nickel alloy, or a combination comprising at least one of the foregoing magnetic materials, or a combination comprising at least one of the foregoing fibers, preferably hexaferrite, magnetite, or MFe₂O₄, wherein M is at least one of Co, Ni, Zn, V, or Mn.

### Embodiment 4

The magneto-dielectric substrate of Embodiment 1, wherein the magnetic reinforcing layer comprises polymer fibers comprising particulate ferrite, a ferrite alloy, cobalt, a cobalt alloy, iron, an iron alloy, nickel, a nickel alloy, or a combination comprising at least one of the foregoing magnetic materials preferably hexaferrite, magnetite, or MFe₂O₄, wherein M is at least one of Co, Ni, Zn, V, or Mn.

### Embodiment 5

The magneto-dielectric substrate of any one or more of Embodiments 1-4, wherein: the first dielectric layer and the second dielectric layer each independently comprises 1,2-polybutadiene, polyisoprene, polybutadiene-polyisoprene copolymers, polyetherimide, fluoropolymers such as polytetrafluoroethylene, polyimide, polyetheretherketone, polyamidimide, polyethylene terephthalate, polyethylene naphthalate, polycyclohexylene terephthalate, polyphenylene ethers, allylated polyphenylene ethers or a combination comprising at least one of the foregoing.

### Embodiment 6

The magneto-dielectric substrate of any one or more of Embodiments 1-5, wherein: the first dielectric layer and the second dielectric layer each independently comprises a polybutadiene and/or a polyisoprene; optionally an ethylene-propylene liquid rubber having a weight average molecular weight of less than or equal to 50,000 g/mol as measured by gel permeation chromatography based on polycarbonate standards; optionally, a dielectric filler; and optionally, a flame retardant.

### Embodiment 7

The magneto-dielectric substrate of any of Embodiments 1-6, wherein: the first dielectric layer fully impregnates one side of the magnetic reinforcing layer; and the second dielectric layer fully impregnates an opposing side of the magnetic reinforcing layer.

### Embodiment 8

The magneto-dielectric substrate of any of the preceding Embodiments, wherein the magnetic reinforcing layer comprises: a first magnetic layer; a second magnetic layer uniformly spaced apart from the first magnetic layer; and a dielectric reinforcement layer disposed between and in intimate contact with the first magnetic layer and the second magnetic layer.

### Embodiment 9

The magneto-dielectric substrate of Embodiment 8, wherein the first magnetic layer and the second magnetic layer each comprise thin film ferrite.

### Embodiment 10

The magneto-dielectric substrate of Embodiment 8, wherein: the first magnetic layer has a first-magnetic-layer thickness; the second magnetic layer has a second-magnetic-layer thickness; the reinforcement layer has a reinforcement-layer thickness; a ratio of the reinforcement-layer thickness to the first-magnetic-layer thickness is equal to or greater than 25; and a ratio of the reinforcement-layer thickness to the second-magnetic-layer thickness is equal to or greater than 25.

### Embodiment 11

The magneto-dielectric substrate of any of the preceding Embodiments, wherein: the first dielectric layer has a first thickness; and the second dielectric layer has a second thickness substantially equal in thickness to the first thickness.

### Embodiment 12

The magneto-dielectric substrate of any of the preceding Embodiments, wherein: the first dielectric layer has a first thickness; and the second dielectric layer has a second thickness substantially equal in thickness to the first thickness.

### Embodiment 13

The magneto-dielectric substrate of any one or more of Embodiments 1 or 6-12, wherein: the first dielectric layer is structurally macroscopically in-plane continuous; and the second dielectric layer is structurally macroscopically in-plane continuous.

### Embodiment 14

The magneto-dielectric substrate of any of the preceding Embodiments, wherein: the magnetic reinforcing layer is at least partially structurally macroscopically in-plane continuous.

### Embodiment 15

The magneto-dielectric substrate of any of the preceding Embodiments, wherein: the magnetic reinforcing layer has in-plane magnetic anisotropy.

### Embodiment 16

The magneto-dielectric substrate of any of the preceding Embodiments, wherein: the first dielectric layer has outer dimensions that define a first footprint; the second dielectric layer has outer dimensions that define a second footprint substantially equal in size to the first footprint; and the magnetic reinforcing layer has outer dimensions that define a third footprint substantially equal in size to the first and second footprints.

### Embodiment 17

The magneto-dielectric substrate of any of the preceding Embodiments, wherein: the first dielectric layer, the second dielectric layer, and the magnetic reinforcing layer, are each planar in structure.

### Embodiment 18

The magneto-dielectric substrate of any of the preceding Embodiments, further comprising: a conductive ground layer disposed on an outer surface of the first dielectric layer; and a conductive element disposed on an outer surface of the second dielectric layer, the conductive element being spaced apart from the conductive ground layer.

### Embodiment 19

The magneto-dielectric substrate of Embodiment 18, wherein: the first dielectric layer has outer dimensions that define a first footprint; the second dielectric layer has outer dimensions that define a second footprint substantially equal in size to the first footprint; the magnetic reinforcing layer has outer dimensions that define a third footprint substantially equal in size to the first and second footprints; the conductive ground layer has outer dimensions that define a fourth footprint substantially equal in size to the first footprint; and the conductive element has outer dimensions that define a fifth footprint that is smaller in size than the second footprint.

### Embodiment 20

The magneto-dielectric substrate of Embodiment 19, wherein: a ratio of an area of the fifth footprint to an area of the second footprint is equal to or less than 0.3.

### Embodiment 21

The magneto-dielectric substrate of Embodiment 20, wherein: the conductive element is centrally disposed on the second dielectric layer.

### Embodiment 22

The magneto-dielectric substrate of any of Embodiments 18-21, further comprising: a signal line disposed in signal communication with the conductive element.

### Embodiment 23

The magneto-dielectric substrate of Embodiment 22, wherein: the signal line comprises a coaxial cable having a central signal conductor disposed in signal communication with the conductive element, and a ground sheath disposed in electrical ground communication with the conductive ground layer.

### Embodiment 24

The magneto-dielectric substrate of any of Embodiments 22-23, wherein: the conductive element is patterned to form in-line and in-plane conductive discontinuities.

### Embodiment 25

The magneto-dielectric substrate of Embodiment 24, wherein: when a 1 GHz signal is communicated to the conductive element via the signal line, the magneto-dielectric substrate is configured to and is capable of radiating the 1 GHz signal into free space at a beam width of at least 122-degrees in an H-field plane, and at a beam width of at least 116-degrees in an E-field plane.

### Embodiment 26

The magneto-dielectric substrate of any of the preceding Embodiments, wherein: the second dielectric layer is uniformly spaced apart from the first dielectric layer.

### Embodiment 27

The magneto-dielectric substrate of any one of Embodiments 22-24, wherein: the conductive ground layer and the conductive element are laminates that form a copper clad circuit laminate; and, when a 1 GHz signal is communicated to the conductive element via the signal line, the magneto-dielectric substrate is configured to and is capable of radiating the 1 GHz signal into free space at a beam width of at least 122-degrees in an H-field plane, and at a beam width of at least 116-degrees in an E-field plane.

While certain combinations of features relating to an antenna have been described herein, it will be appreciated that these certain combinations are for illustration purposes only and that any combination of any of these features may be employed, explicitly or equivalently, either individually or in combination with any other of the features disclosed herein, in any combination, and all in accordance with an embodiment. Any and all such combinations are contemplated herein and are considered within the scope of the disclosure.

While the invention has been described with reference to exemplary embodiments, it will be understood by those skilled in the art that various changes may be made and equivalents may be substituted for elements thereof without departing from the scope of this disclosure. In addition, many modifications may be made to adapt a particular situation or material to the teachings without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments and, although specific terms may have been employed, they are unless otherwise stated used in a generic and descriptive sense only and not for purposes of limitation.

I/we claim:

1. A magneto-dielectric substrate, comprising:
a first dielectric layer;
a second dielectric layer spaced apart from the first dielectric layer; and
at least one magnetic reinforcing layer disposed between and in intimate contact with the first dielectric layer and the second dielectric layer.

2. The magneto-dielectric substrate of claim 1, wherein the magnetic reinforcing layer comprises fibers, wherein the fibers are ferrite fibers, ferrite alloy fibers, cobalt fibers, cobalt alloy fibers, iron fibers, iron alloy fibers, nickel fibers, nickel alloy fibers, polymer fibers comprising particulate ferrite, a particulate ferrite alloy, particulate cobalt, a particulate cobalt alloy, particulate iron, a particulate iron alloy, particulate nickel, a particulate nickel alloy, or a combination comprising at least one of the foregoing, preferably hexaferrite, magnetite, or MFe₂O₄, wherein M is at least one of Co, Ni, Zn, V, or Mn.

3. The magneto-dielectric substrate of claim 1, wherein the magnetic reinforcing layer comprises polymer or glass fibers coated with ferrite, a ferrite alloy, cobalt, a cobalt alloy, iron, an iron alloy, nickel, a nickel alloy, or a combination comprising at least one of the foregoing magnetic materials, or a combination comprising at least one of the foregoing fibers, preferably hexaferrite, magnetite, or MFe₂O₄, wherein M is at least one of Co, Ni, Zn, V, or Mn.

4. The magneto-dielectric substrate of claim 1, wherein the magnetic reinforcing layer comprises polymer fibers comprising particulate ferrite, a ferrite alloy, cobalt, a cobalt alloy, iron, an iron alloy, nickel, a nickel alloy, or a combination comprising at least one of the foregoing magnetic materials preferably hexaferrite, magnetite, or MFe₂O₄, wherein M is at least one of Co, Ni, Zn, V, or Mn.

5. The magneto-dielectric substrate of claim 1, wherein:
the first dielectric layer and the second dielectric layer each independently comprises 1,2-polybutadiene, polyisoprene, polybutadiene-polyisoprene copolymers, polyetherimide, fluoropolymers such as polytetrafluoroethylene, polyimide, polyetheretherketone, polyamidimide, polyethylene terephthalate, polyethylene naphthalate, polycyclohexylene terephthalate, polyphenylene ethers, allylated polyphenylene ethers or a combination comprising at least one of the foregoing.

6. The magneto-dielectric substrate of claim 1, wherein:
the first dielectric layer and the second dielectric layer each independently comprises a polybutadiene and/or a polyisoprene;
optionally an ethylene-propylene liquid rubber having a weight average molecular weight of less than or equal to 50,000 g/mol as measured by gel permeation chromatography based on polycarbonate standards;
optionally, a dielectric filler; and
optionally, a flame retardant.

7. The magneto-dielectric substrate of claim 1, wherein:
the first dielectric layer fully impregnates one side of the magnetic reinforcing layer; and
the second dielectric layer fully impregnates an opposing side of the magnetic reinforcing layer.

8. The magneto-dielectric substrate of claim 1, wherein the magnetic reinforcing layer comprises:
a first magnetic layer;
a second magnetic layer uniformly spaced apart from the first magnetic layer; and
a dielectric reinforcement layer disposed between and in intimate contact with the first magnetic layer and the second magnetic layer.

9. The magneto-dielectric substrate of claim 8, wherein the first magnetic layer and the second magnetic layer each comprise thin film ferrite.

10. The magneto-dielectric substrate of claim 8, wherein:
the first magnetic layer has a first-magnetic-layer thickness;
the second magnetic layer has a second-magnetic-layer thickness;
the reinforcement layer has a reinforcement-layer thickness;
a ratio of the reinforcement-layer thickness to the first-magnetic-layer thickness is equal to or greater than 25; and
a ratio of the reinforcement-layer thickness to the second-magnetic-layer thickness is equal to or greater than 25.

11. The magneto-dielectric substrate of claim 1, wherein:
the first dielectric layer has a first thickness; and
the second dielectric layer has a second thickness substantially equal in thickness to the first thickness.

12. The magneto-dielectric substrate of claim 1, wherein:
the first dielectric layer has a first thickness; and
the second dielectric layer has a second thickness substantially equal in thickness to the first thickness.

13. The magneto-dielectric substrate of claim 1, wherein:
the first dielectric layer is structurally macroscopically in-plane continuous; and
the second dielectric layer is structurally macroscopically in-plane continuous.

14. The magneto-dielectric substrate of claim 1, wherein:
the magnetic reinforcing layer is at least partially structurally macroscopically in-plane continuous.

15. The magneto-dielectric substrate of claim 1, wherein:
the magnetic reinforcing layer has in-plane magnetic anisotropy.

16. The magneto-dielectric substrate of claim 1, wherein:
the first dielectric layer has outer dimensions that define a first footprint;
the second dielectric layer has outer dimensions that define a second footprint substantially equal in size to the first footprint; and
the magnetic reinforcing layer has outer dimensions that define a third footprint substantially equal in size to the first and second footprints.

17. The magneto-dielectric substrate of claim 1, wherein:
the first dielectric layer, the second dielectric layer, and the magnetic reinforcing layer, are each planar in structure.

18. The magneto-dielectric substrate of claim 1, further comprising:
a conductive ground layer disposed on an outer surface of the first dielectric layer; and
a conductive element disposed on an outer surface of the second dielectric layer, the conductive element being spaced apart from the conductive ground layer.

19. The magneto-dielectric substrate of claim 18, wherein:
the first dielectric layer has outer dimensions that define a first footprint;
the second dielectric layer has outer dimensions that define a second footprint substantially equal in size to the first footprint;
the magnetic reinforcing layer has outer dimensions that define a third footprint substantially equal in size to the first and second footprints;
the conductive ground layer has outer dimensions that define a fourth footprint substantially equal in size to the first footprint; and
the conductive element has outer dimensions that define a fifth footprint that is smaller in size than the second footprint.

20. The magneto-dielectric substrate of claim 19, wherein:
a ratio of an area of the fifth footprint to an area of the second footprint is equal to or less than 0.3.

21. The magneto-dielectric substrate of claim 20, wherein:
the conductive element is centrally disposed on the second dielectric layer.

22. The magneto-dielectric substrate of claim 18, further comprising:
a signal line disposed in signal communication with the conductive element.

23. The magneto-dielectric substrate of claim 22, wherein:
the signal line comprises a coaxial cable having a central signal conductor disposed in signal communication with the conductive element, and a ground sheath disposed in electrical ground communication with the conductive ground layer.

24. The magneto-dielectric substrate of any of claim 22, wherein:
the conductive element is patterned to form in-line and in-plane conductive discontinuities.

25. The magneto-dielectric substrate of claim 24, wherein:
when a 1 GHz signal is communicated to the conductive element via the signal line, the magneto-dielectric substrate is configured to and is capable of radiating the 1 GHz signal into free space at a beam width of at least 122-degrees in an H-field plane, and at a beam width of at least 116-degrees in an E-field plane.

26. The magneto-dielectric substrate of claim 1, wherein:
the second dielectric layer is uniformly spaced apart from the first dielectric layer.

27. The magneto-dielectric substrate of claim 22, wherein:
the conductive ground layer and the conductive element are laminates that form a copper clad circuit laminate; and
when a 1 GHz signal is communicated to the conductive element via the signal line, the magneto-dielectric substrate is configured to and is capable of radiating the 1 GHz signal into free space at a beam width of at least 122-degrees in an H-field plane, and at a beam width of at least 116-degrees in an E-field plane.
